(19) United States
(12) Patent Application Publication
(10) Pub. No.: US 2026/0312536 A1
(43) Pub. Date: Oct. 8, 2026

(54) PHOTOVOLTAIC MODULE INTERLOCK SYSTEMS

(71) Applicant: Tesla, Inc., Austin, TX (US)

(72) Inventor: Martin SEERY, Austin, TX (US)

(73) Assignee: Tesla, Inc., Austin, TX (US)

(21) Appl. No.: 19/173,563

(22) Filed: Apr. 8, 2025

(51) Int. Cl. H02S 40/36; H01R 4/26

(52) U.S. Cl. CPC H02S 40/36; H01R 4/26

(57) ABSTRACT

The systems and methods of the present disclosure can include an interlock system. The interlock system can include a plate defining a first aperture, a second aperture, and a third aperture, a spacer removably coupled to the plate and extending at least partially through the second aperture, the spacer including a first adjustable tab and a second adjustable tab, the spacer movable through the second aperture via the first adjustable tab and the second adjustable tab, a first electrical connector coupled to the plate and extending at least partially through the first aperture, the first electrical connector configured to rotate to form an electrical connection, and a second electrical connector coupled to the plate and extending at least partially through the third aperture, the second electrical connector configured to rotate to form the electrical connection.

### TECHNICAL FIELD

The present disclosure relates generally to photovoltaic module installation devices, and more particularly to photovoltaic module interlock systems.

### BACKGROUND

Photovoltaic modules, such as solar panels, can be installed on structures such as roofs. It can be challenging to reliably perform the installation in a manner that addresses factors such as proper alignment, stability, orientation, and electrical connection of the photovoltaic modules.

### SUMMARY

At least one aspect of the present disclosure is directed towards an interlock system for photovoltaic modules, including a plate defining a first aperture, a second aperture, and a third aperture, a spacer removably coupled to the plate and extending at least partially through the second aperture, the spacer including a first adjustable tab and a second adjustable tab, the spacer movable through the second aperture via the first adjustable tab and the second adjustable tab, a first electrical connector coupled to the plate and extending at least partially through the first aperture, the first electrical connector configured to rotate to form an electrical connection, and a second electrical connector coupled to the plate and extending at least partially through the third aperture, the second electrical connector configured to rotate to form the electrical connection.

In various implementations, the spacer can include a first end having a top surface and a bottom surface, the bottom surface opposite the top surface, the first adjustable tab extends from the top surface at a first angle between five to twenty five degrees, inclusive; and the second adjustable tab extends from the bottom surface at a second angle between five to twenty five degrees, inclusive.

In various implementations, the spacer can include a second end opposite the first end, the second end having a height and a width greater than a height and a width of the second aperture. The plate can include an electrically conductive material. The plate can have a length between one hundred and thirty to one hundred and fifty millimeters (mm), inclusive, and a height between twenty five to forty five mm, inclusive. The spacer can include an electrically insulating material.

In various implementations, the second aperture can be located between the first aperture and the third aperture, the first aperture and the third aperture equidistant from the second aperture and at least one of the first electrical connector or the second electrical connector can include at least one protrusion, the at least one protrusion configured to gouge into the plate as the first electrical connector and the second electrical connector are rotated.

In various implementations, at least one of the first electrical connector and the second electrical connector has a first position, a second position, and a third position, the first position corresponding to an unrotated state, the second position corresponding to a partially rotated state, and the third position corresponding to a rotated state, the first electrical connector and the second electrical connector forming the electrical connection in the third position, at least one of the first electrical connector or the second electrical connector can include a first indicator corresponding to the first position, a second indicator corresponding to the second position, and a third indicator corresponding to the third position, and the first indicator extends along a first axis and the third indicator extends along a third axis, the third axis intersecting the first axis at an angle between eighty eight to ninety two degrees, inclusive.

At least one aspect of the present disclosure is directed towards a module system. The module system can include a plurality of modules configured to generate electricity and at least one interlock device configured to space the plurality of modules apart and electrically connect at least a portion of the plurality of modules. The interlock device can include a plate defining a first aperture, a second aperture, and a third aperture, a spacer coupled to the plate and extending at least partially and movable through the second aperture, the spacer in contact with at least two of the plurality of modules and configured to separate the at least two of the plurality of modules, a first electrical connector coupled to the plate and extending at least partially through the first aperture configured to electrically connect at least a portion of the plurality of modules, and a second electrical connector coupled to the plate and extending at least partially through the second aperture configured to electrically connect the at least the portion of the plurality of modules.

In various implementations, the first electrical connector includes a first end configured to contact at a first module of the plurality of modules and a second end configured to face a second module of the plurality of modules. The second electrical connector can include a first end configured to contact at a third module of the plurality of modules and a second end configured to face a fourth module of the plurality of modules. In various implementations, the third module is same as the first module, or the second module is same as the fourth module.

In various implementations, the first end of the first electrical connector and the first end of the second electrical connector can have a corner with an angle between eighty five to ninety five degrees, inclusive, the corner limiting the first electrical connector and the second electrical connector from rotating beyond between eighty eight to ninety two degrees, inclusive. At least one of the first electrical connector or the second electrical connector have a first position, a second position, and a third position, the first position corresponding to an unrotated state, the second position corresponding to a partially rotated state, and the third position corresponding to a rotated state. The at least one interlock device can electrically connect the at least the portion of the plurality of modules in response to at least one of the first electrical connector or the second electrical connector being in the third position.

In various implementations, at least one of the second end of the first electrical connector or the second end of the second electrical connector can include a first indicator, a second indicator, and a third indicator, the first indicator corresponding to the first position, the second indicator corresponding to the second position, and the third indicator corresponding to the third position and the first indicator extends along a first axis and the third indicator extends along a third axis, the third axis intersecting the first axis at an angle between eighty eight to ninety two degrees, inclusive.

In various implementations, the spacer can be in a first position, second position, or removed from the at least one interlock device, the spacer in contact with two modules of the plurality of modules in the first position and the second position.

In various implementations, the plate can include a top surface including a first mark aligned with a midpoint of the first aperture, a second mark aligned with a first edge of the second aperture, a third mark aligned with a midpoint of the second aperture, a fourth mark aligned with a second end of the second aperture, and a fifth mark aligned with a midpoint of the third aperture. The plate can include a back surface contiguous with the top surface including a plurality of protrusions configured to facilitate alignment of the at least one interlock device with at least one of the plurality of modules.

At least one aspect of the present disclosure is directed towards an interlock apparatus. The interlock apparatus can include a plate defining a first opening, a second opening, and a third opening, the second opening located between the first opening and the third opening and a spacer extending and movable through the second opening. The spacer can be coupled to the plate extending at least partially and movable through the second opening. The spacer can include a first surface, a first prong extending from the first surface, a second surface, and a second prong extending from the second surface. The first prong and the second prong can have a first state and a second state, the first prong and the second prong located closer to each other in the second state than the first state, the spacer movable through the second opening when the first prong and the second prong are in the second state.

In various implementations, the spacer includes a flexible electrically insulating material, and the first prong and the second prong configured to be pushed together to adjust from the first state to the second state. The interlock apparatus can include at least one electrical connector coupled to the plate and extending at least partially through at least one of the first opening or the third opening, the at least one electrical connector to rotate to form an electrical connection.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an example system including an example interlock system;

FIG. 2 is a top view of an example system;

FIG. 3 is a perspective view of an example interlock system;

FIG. 4 is a back view of the interlock system of FIG. 3;

FIG. 5 is another perspective view the interlock system of FIG. 3;

FIG. 6 is another perspective view of the interlock system of FIG. 3;

FIG. 7 is an exploded view of the interlock system of FIG. 3;

FIG. 8 is a cross-sectional view of the interlock system of FIG. 3;

FIG. 9A is a top view of positions of an example spacer assembly of the interlock system of FIG. 3.

FIG. 9B is a top view of positions of an example spacer assembly of an example interlock system;

FIG. 10A is a perspective view of the system of FIG. 2;

FIG. 10B is a perspective view of an example system including an example interlock system;

FIG. 11 is a schematic, side view of a portion of an example interlock system;

FIG. 12 is a schematic, side view of a portion of an example interlock system;

FIG. 13 is a schematic, side view of a portion of an example interlock system; and

FIG. 14 is an example method for installing an example system.

### DETAILED DESCRIPTION

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

Interlock systems in accordance with the present disclosure can separate and electrically connect modules (e.g., panels, cells, etc.) The modules can be photovoltaic (PV) modules (e.g., solar panels, etc.) that convert sunlight into electricity. The interlock system can facilitate installation of the modules. The interlock system can separate each of the modules to mitigate overheating of the modules. The separation of the modules can additionally account for thermal expansion of the modules and wind load dynamics to mitigate damage to the modules. The interlock system can electrically connect rows (e.g., lines, series, etc.) of the modules to each other to, for example, ground the rows of the modules to protect the modules from fault currents and dissipating static electricity, thereby mitigating shock hazards and overheating. The interlock system in accordance with the present disclosure can simplify an installation process of the modules and ensure adequate spacing between each of the modules.

The interlock system can include a spacing assembly to ensure the adequate spacing between each of the modules. The spacer can be located between at least two modules to space the modules apart, and the at least two modules can be in contact with the spacer. The interlock system can be placed between two modules, and the spacer can be positioned based on a configuration of the modules adjacent to the interlock system. The spacer can engage with the modules the spacer is in contact with.

The interlock system can include electrical connectors to electrically connect the first module and the second module. The electrical connectors can provide module to module grounding along rows of modules and can electrically connect each module in a row of modules.

Conventional interlock systems may not include a spacer and require specific tools for installing the electrical connector thereby increasing a difficulty and time needed for installation. For example, mechanics (e.g., workers, engineers, etc.) installing the modules and interlock systems may use processes or indicators to precisely align and space apart the modules, thereby increasing the installation time. Connectors of the systems can be over rotated by the tools, causing the connectors to impart a greater force onto the modules and increase a strain and stress on the interlock system. Conventional interlock systems may provide structure for and/or bear at least a portion of the load of modules. This can result in such components being larger and/or having a greater mass, thereby being more difficult and costly to manufacture.

Interlock systems in accordance with the present disclosure can facilitate electrical connection between modules and space the modules apart such that the modules are not in contact with each other. The interlock system can be removably coupled from the modules and include a spacer having at least three positions. The spacer can be positioned depending on a position of the modules in relation to the interlock system. For example, for an interlock system positioned between three modules, the spacer is in a first position. The spacer can increase an efficiency of installing the modules by defining a physical space between the modules instead of providing, for example, a ruler to space apart the modules. For example, the spacer can provide a mechanical stop to movement of the modules relative to the interlock, to provide a mechanical response indicative of correct alignment. The interlock system can include at least one electrical connector to rotate and connect one module to another module. The electrical connectors can be rotated without specific tools and can include indicators to facilitate installation of the electrical connectors to improve an efficiency of the installation process. The electrical connectors can additionally ground the modules along rows of the modules. The interlock systems in accordance with the present disclosure can be smaller and have less components than conventional systems, thereby decreasing a weight and manufacturing complexity.

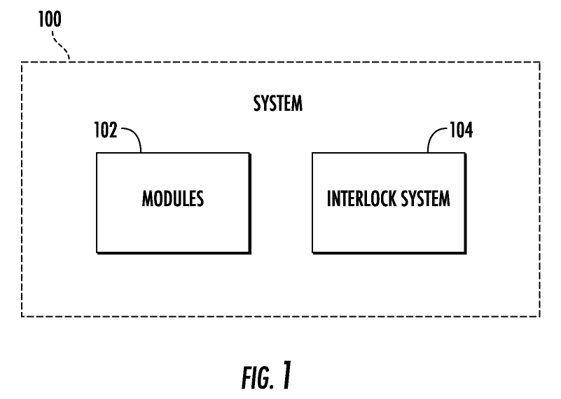

FIG. 1 depicts a system 100 (e.g., module system, solar panel system, photovoltaic module system, etc.) The system 100 can include at least one module 102 (e.g., photovoltaic module, panel, subassembly, section, unit, array element, etc.) The module 102 can be a PV module, and can convert sunlight into electricity using solar cells (e.g., PV cell, etc.) The solar cell can generate electrical current when exposed to sunlight due to the photovoltaic effect and can be formed from semiconductor materials such as silicon. The module 102 can provide the electricity to, for example, a power grid, a battery, an inverter, electronic devices, etc. The module 102 can generate direct current (DC) electricity and can provide the DC electricity to the inverter to convert to alternating current (AC) electricity. The AC electricity can then be provided to power electronic devices, such as devices in businesses or homes (e.g., computers, fridges, phones, etc.)

The module 102 can produce electricity by absorbing sunlight and can be placed and positioned to receive sunlight. For example, the module 102 can be placed on a roof of a home or building or any other angled surface to maximize sun exposure of the module 102. In various implementations, the angle of the module 102 can be adjusted based on the season. For example, an angle of the module 102 relative to the ground can be increased in the winter to capture lower sun angles and decreased in the summer to capture higher sun angles.

The system 100 can include at least one interlock system 104 (e.g., attachment device, circuit interlock, interlock device, etc.) The interlock system 104 can be for the modules 102. The interlock system 104 can be positioned between modules 102 and configured to ensure proper alignment between modules 102 and provide a conduit to electrically (e.g., serially) connect rows of the modules 102 (e.g., at least a portion of the modules 102) in the system 100. The interlock system 104 can space the modules 102 apart to allow for airflow, provide space between the modules 102 for thermal expansion of the modules 102, and can ground the modules 102 to protect against electrical faults and reduce risk of fires and shock hazards. For example, without proper spacing between modules 102, a module 102 may cast shadows on another module 102, thereby reducing the energy output of another module 102. Furthermore, the interlock system 104 spacing between modules 102 can reduce mechanical stress on the system 100 and mitigate wind uplift which can damage or dislodge the modules 102. The interlock system 104 can provide a secure electrical connection between modules 102, mitigate a risk of loose electrical connections or accidentally disconnections, and can simplify an electrical connection process of the modules 102, thereby increasing an efficiency of the installation process of the system 100. Specifically, the interlock system 104 can electrically connect rows of the modules 102 such that each row of modules 102 in the system 100 is grounded. For example, each row of the modules 102 can be electrically coupled to a grounding wire to ground each row of the modules 102. The interlock system 104 may not bear a load from the modules 102.

The system 100 can be mounted onto a roof or tilted frames on the ground or a raised surface. To mount the system 100, mounting brackets (e.g., rails, etc.) or a racking structure (e.g., deck, etc.) can be installed, and the modules 102 can be placed onto and coupled to the mounting brackets or structure, and the interlock system 104 can be placed between the modules 102 as the modules 102 are being coupled to the mounting brackets. For example, a first module 102 and a second module 102 can be placed onto the mounting bracket, and a first interlock system 104 can be placed in contact with the first module 102 and the second module 102. The first interlock system 104 can space apart the first module 102 and the second module 102 and electrically connect the first module 102 and the second module 102.

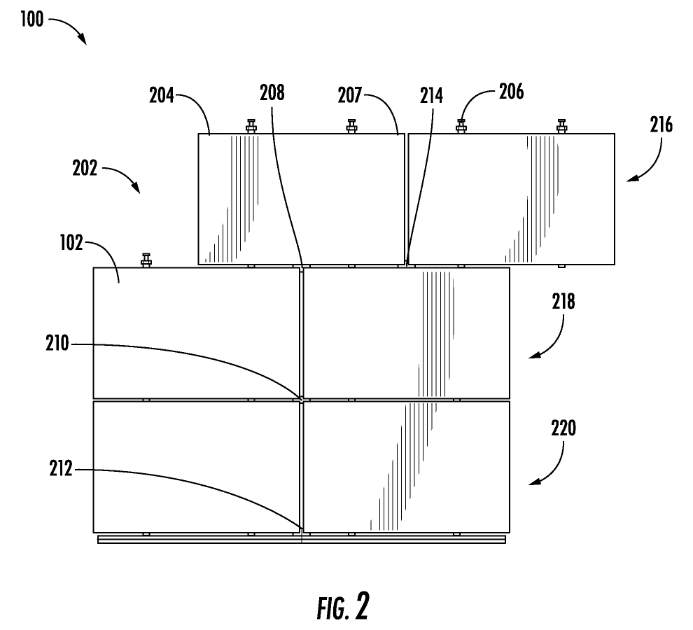

FIG. 2 depicts a top view of an arrangement of the modules 102. The modules 102 can be mounted onto a rack (e.g., frame, mount, angled surface, etc.) and can be positioned as shown in FIG. 2. The modules 102 can form an array 202. The array 202 can include a surface 204 on a periphery (e.g., outer edge) of the array 202. For example, the surface 204 can be a surface of the modules 102 not in contact with another module 102. The surface 204 can include at least one bolt 206 (e.g., fastener, screw, clamp, etc.) to couple the modules 102 to the rack. The modules 102 can include at least one frame 207 (e.g., border, etc.) extending around the module 102. The frame 207 can provide structural support to the module 102 and protect edges of the module 102 from damage. The frame 207 can include at least one of ridges, holes, grooves, or other components to mount the modules 102 to the rack and other devices or systems, such as the interlock system 104.

At least one interlock system 104 can be placed at corners of the modules 102. For example, the interlock system 104 can be placed at points 208, 210, 212, and 214, as shown in FIG. 2. The interlock system 104 can be placed after at least two of the modules 102 are mounted. For example, the system 100 can include a first module 102 which can be mounted to the rack first and then a second module 102.The interlock system 104 at the point 208 can be mounted and placed in contact with the first module 102 and the second module 102. . Following placement of the first module 102 and the second module 102, additional modules 102 can be coupled to the rack and interlock systems 104 can be placed and attached after additional modules 102 are mounted to the rack. For example, following placement of a third module 102 adjacent to the second module 102, the interlock system 104 can be placed between the second module 102 and the third module 102. The interlock system 104 can be in contact with and coupled to the frame 207. The interlock system 104 can be in contact with the surface 204, such as at the point 212.

The system 100 can include at least one row of the modules 102. As shown in FIG. 2, the modules 102, can include a first row 216, a second row 218, and a third row 220. The modules 102 can be grounded along the rows. For example, the modules 102 included in the first row 216 can be electrically coupled via the interlock system 104 and can be electrically coupled to at least one grounding wire. In various implementations, the system 100 includes one grounding wire, and each of the first row 216, the second row 218, and the third row 220 are electrically coupled to the one grounding wire to ground each of the first row 216, the second row 218, and the third row 220.

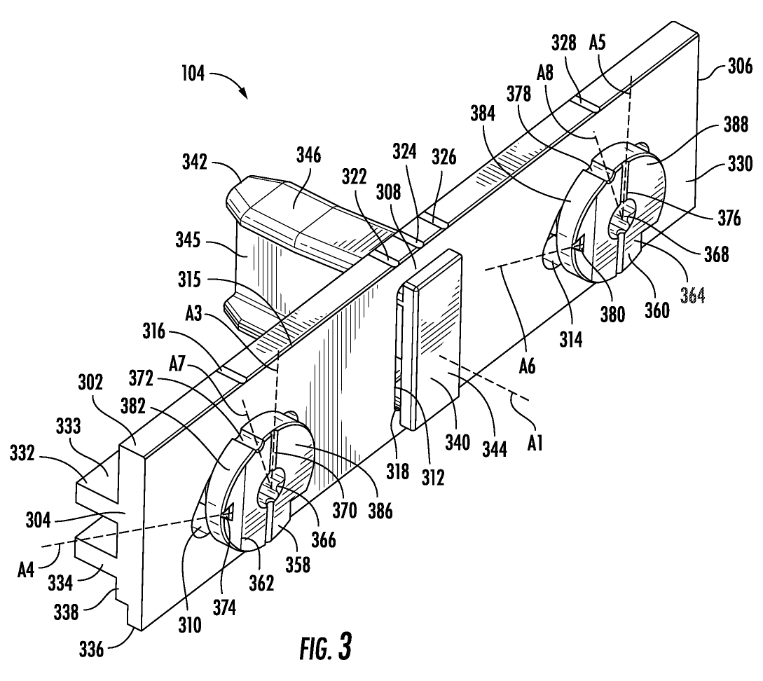

FIGS. 3-8 depict various views of an example interlock system 104, according to various implementations of the present disclosure. The interlock system 104 spaces modules 102 apart and electrically connects modules 102.

The interlock system 104 can include at least one plate 302 (e.g., member, sheet, panel etc.) The plate 302 can be formed of a material including at least one of a metal, ceramic, plastic, or any other material. The plate 302 can be formed from an electrically conductive material. For example, the plate 302 can be formed of aluminum. The plate 302 can have a length between 130 (e.g., one hundred and thirty) to 150 millimeters (e.g., one hundred and fifty) (mm), inclusive, and a height between 25 (e.g., twenty five) to 45 (e.g., forty five) mm, inclusive. The plate 302 can be in contact with at least one module 102. The plate 302 can have a rectangular shape.

The plate 302 can include at least one end. The plate 302 can include a first end 304 and a second end 306 opposite the first end 304. The plate 302 can extend from the first end 304 to the second end 306 and can include a midpoint 308 between the first end 304 and the second end 306. The plate 302 can define at least one aperture (e.g., opening, etc.) The plate 302 can include (e.g., define) a first aperture 310, a second aperture 312, and a third aperture 314. The second aperture 312 can be located at the midpoint 308 such that the second aperture 312 is equidistant from the first end 304 and the second end 306. In various implementations, the second aperture 312 is offset from the midpoint 308. The second aperture 312 can be located between the first aperture 310 and the third aperture 314. In various implementations, the first aperture 310 and the third aperture 314 are located at different distances on the plate 302 from the second aperture 312. The first aperture 310 can be located between the first end 304 and the second aperture 312, and the third aperture 314 can be located between the second end 306 and the second aperture 312.

The second aperture 312 can have a generally rectangular shape and can have a width between 9 (e.g., nine) to 15 (e.g., fifteen) mm, inclusive, and a height of 20 (e.g., twenty) to 30 (e.g., thirty) mm inclusive. The first aperture 310 and the third aperture 314 can have a same shape. The first aperture 310 and the third aperture 314 can have curved edges and can have a height less than the height of the second aperture 312, and a width greater than the width of the second aperture 312. The first aperture 310 and the third aperture 314 can have a shape including a circle and curved edges extending from the circle. The circle can have a diameter between 10 (e.g., ten) to 20 (e.g., twenty) mm, inclusive. The curved edges of the first aperture 310 and the third aperture 314 can have a radius of between 1 (e.g., one) to 8 (e.g., eight) mm, inclusive. The curved edges of the first aperture 310 and the third aperture 314 can have a height between 8 to 16 (e.g., sixteen) mm, inclusive.

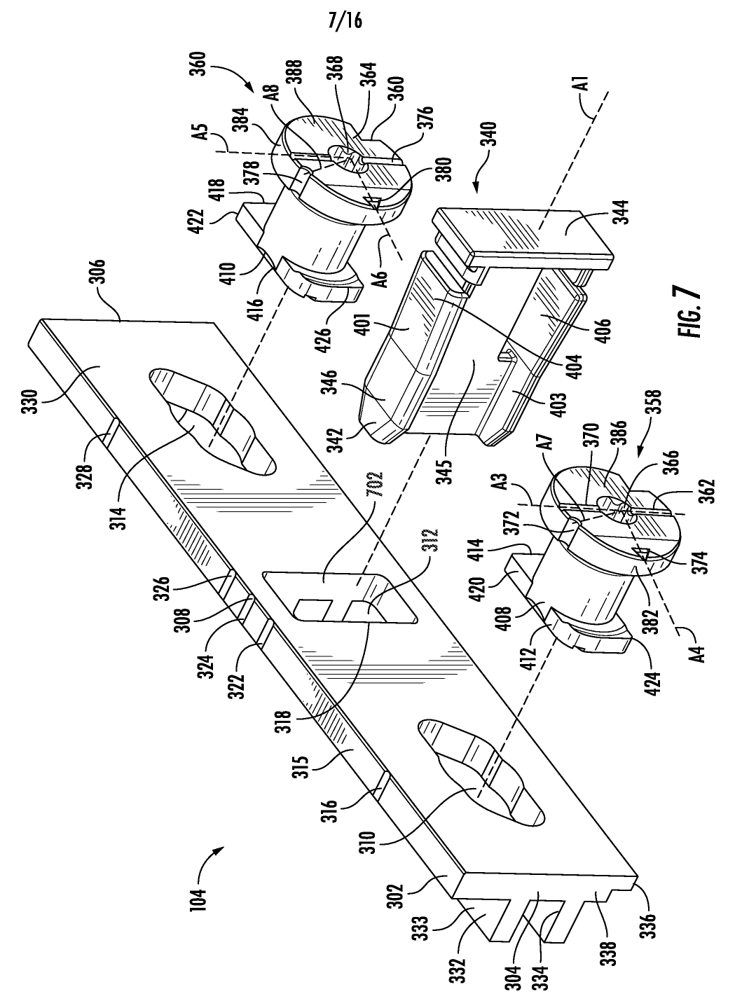

The plate 302 can include at least one surface. The plate 302 can include a top surface 315. The top surface 315 can include at least one marking (e.g., indicator, mark, etc.) The top surface 315 can include a first marking 316 aligned with a midpoint (e.g., middle) of the first aperture 310. The first marking 316 can be aligned with the midpoint 308. The second aperture 312 can include at least one edge. The second aperture 312 can include a first edge 318 and a second edge 702 (as shown in FIG. 7) opposite the first edge 318. The top surface 315 can include a second marking 322 aligned with the first edge 318, a third marking 324 aligned with a midpoint of the second aperture 312 (e.g., the midpoint 308), a fourth marking 326 aligned with the second edge 702, and a fifth marking 328 aligned with a midpoint of the third aperture 314. The second marking 322, the third marking 324, and the fourth marking 326 can be used to space apart the modules 102. For example, a space between a first module 102 and a second module 102 can be defined by a distance between the second marking 322 and the fourth marking 326.

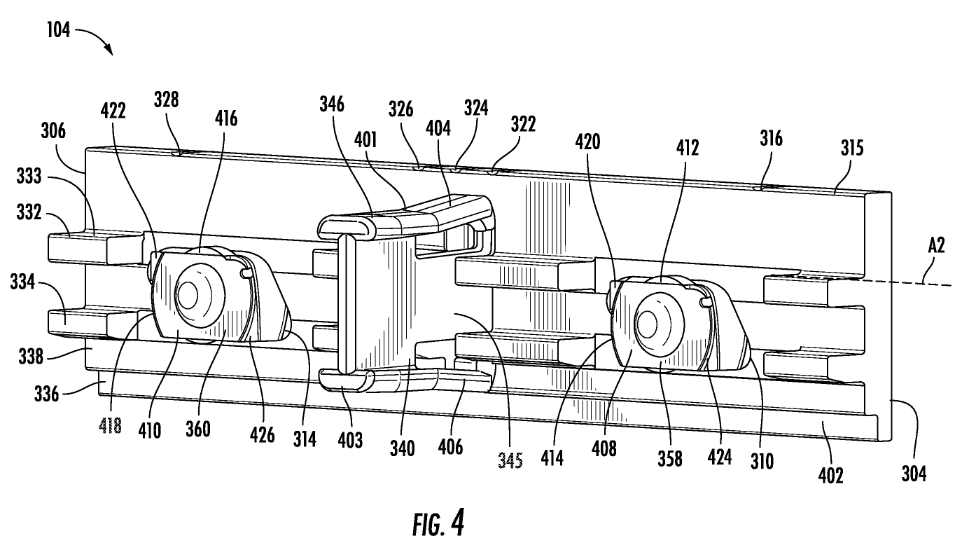

Referring to FIG. 4, the plate 302 can include a back surface 402 contiguous with the top surface 315. The plate 302 can include a front surface 330 opposite the back surface 402. The first aperture 310, the second aperture 312, and the third aperture 314 can extend from the back surface 402 to the front surface 330. The back surface 402 can include at least one protrusion (e.g., raised surface, extension). The back surface 402 can include at least one first protrusion 332 and at least one second protrusion 334. The first protrusion 332 and the second protrusion 334 can extend from the back surface 402. The first protrusion 332 and the second protrusion 334 can define a thickness of the plate 302, which can be between 9 to 16 mm, inclusive. The first protrusion 332 and the second protrusion 334 can be in contact with at least one module 102 and can facilitate alignment and attachment of the interlock system 104 to at least one of the modules 102. The first protrusion 332 and the second protrusion 334 can be in contact with the frame 207 of the module 102. In various implementations, the first protrusion 332 and the second protrusion 334 are hooked onto or inserted into the frame 207 of the at least one module 102. For example, the first protrusion 332 and the second protrusion 334 can mate with the frame 207 of the module 102.

The plate 302 can include a bottom surface 336 opposite the top surface 315. The bottom surface 336 can be contiguous with the back surface 402. The first protrusion 332 can be located closer to the top surface 315 than the bottom surface 336 on the back surface 402, and the second protrusion 334 can be located closer to the bottom surface 336 than the top surface 315. The first protrusion 332 can be a plurality of first protrusions 332, as shown in FIG. 4, and can be located between the first end 304 and the first aperture 310, between the first aperture 310 and the second aperture 312, between the second aperture 312 and the third aperture 314, and between the third aperture 314 and the second end 306. The second protrusion 334 can be a plurality of second protrusions 334 and can be located between the first end 304 and the first aperture 310, between the first aperture 310 and the second aperture 312, between the second aperture 312 and the third aperture 314, and between the third aperture 314 and the second end 306.

The first protrusion 332 and the second protrusion 334 can have a height between 3 (e.g., three) to 5 mm. In various implementations, the first protrusion 332 and the second protrusion 334 can have a same height or different heights. A distance between the first protrusion 332 and the second protrusion 334 on the back surface 402 can be between 4 (e.g.., four) to 9 mm, inclusive.

The plate 302 can include a third protrusion 338 extending from the back surface 402 and in contact with the second protrusion 334. In various implementations, the third protrusion 338 can be integrated with or included in the second protrusion 334. The third protrusion 338 can be located between the bottom surface 336 and the second protrusion 334 and can have a length less than the first protrusion 332 and the second protrusion 334. The third protrusion 338 can mate with the frame 207 of the module 102 and be configured to attach the interlock system 104 with the frame 207 of the at least one module 102. A distance of the third protrusion 338 from the bottom surface 336 can be between 2 (e.g., two) to 6 (e.g., six) mm, inclusive. The first protrusion 332, the second protrusion 334, and the third protrusion 338 can mate with and be at least partially inserted into the frame 207. The first protrusion 332, the second protrusion 334, and the third protrusion 338 can facilitate attachment of the interlock system 104 to the module 102.

The interlock system 104 can include at least one spacer 340 (e.g., spacing assembly, etc.) The spacer 340 can contact the modules 102 and be configured to space the modules 102 apart. The spacer 340 can contact at least two modules 102 to separate the at least two modules 102. The spacer 340 can ensure that the modules 102 are properly spaced apart and simplify the installation process of the modules 102. In various implementations, the spacer 340 can slide against the frame 207 of the modules 102. The interlock system 104 and the spacer 340 can be in contact with the first module 102 and a second module 102, and the interlock system 104 and the spacer 340 can align and space apart the first module 102 and the second module 102. At least a portion of the spacer 340 can mate with or be inserted into the frame 207 of the module 102 as the spacer 340 engages with the frame 207 of the module 102. The spacer 340 can be formed from a material, such as plastic, ceramic, metal, or any other material. The spacer 340 can be formed from a bendable (e.g., flexible) material such as a plastic. The spacer 340 can be formed from an electrically insulating material such that an electric current does not pass through the spacer 340. The spacer 340 can be formed from a flexible electrically insulating material. The spacer 340 can define and extend along a first axis A1.

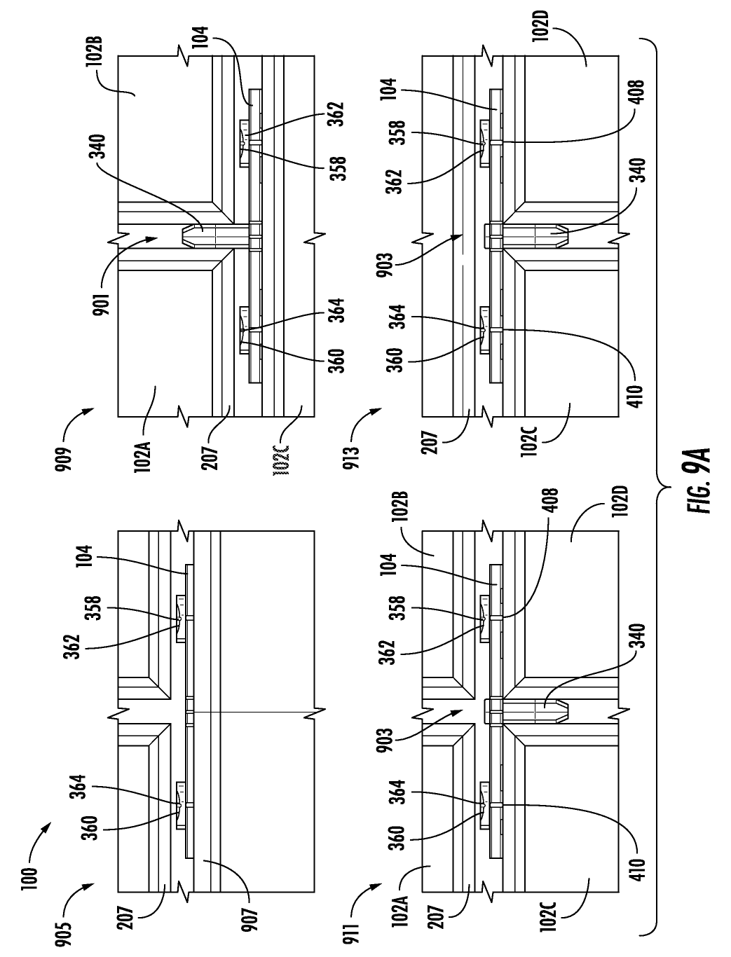

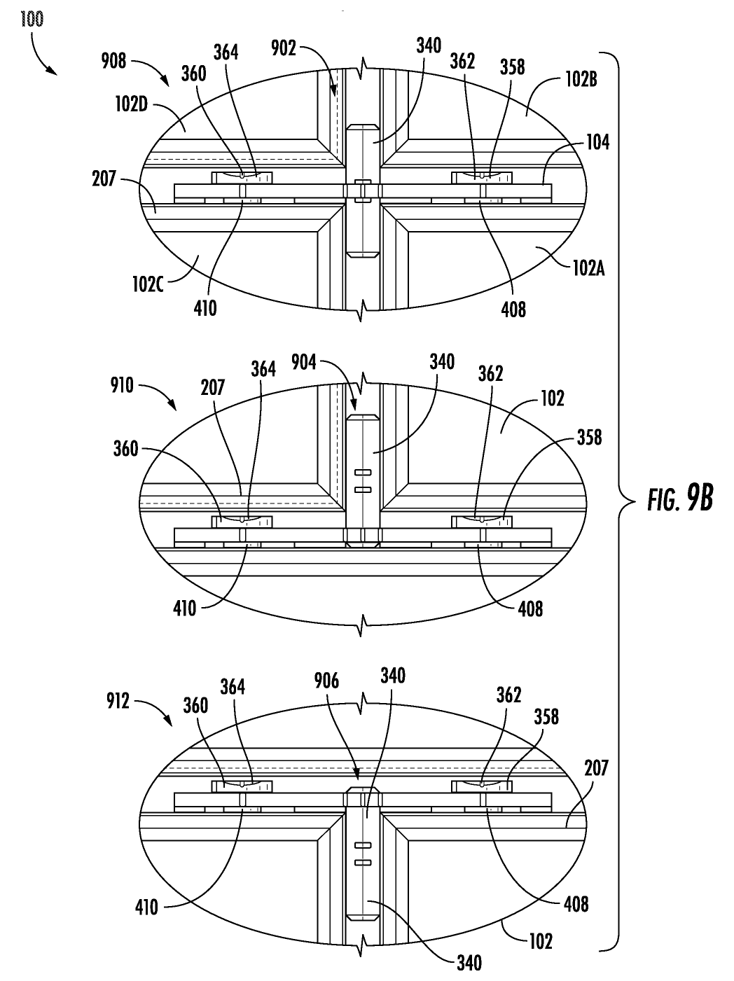

The spacer 340 can be coupled to the plate 302 and extend at least partially through the second aperture 312. The spacer 340 can be removably coupled to the plate 302. The spacer 340 can extend at least partially through the second aperture 312 and can move through the second aperture 312. For example, the spacer 340 can be movable between positions, as shown in at least FIG. 9A (as described further herein). The spacer 340 can be movable between at least a first position 901, a second position 903, or removed. In the first position 902 and the second position 903, the spacer 340 can be in contact with two modules 102. For example, the spacer 340 at the point 208 can be in second position 903, at the point 210, the spacer 340 can be in the second position 903 and at the points 212 and 214, the spacer 340 can be in the first position 901. After placement of the interlock system 104, the spacer 340 can be removed from the interlock system 104. As another example, the interlock system 104 shown in FIGS. 3-6 and 8 can show the spacer 340 in the second position 903. In various implementations, the spacer 340 can be in contact with four modules 102.

As another example, referring back to FIG. 2, the first row 216 can be offset from the second row 218 and the third row 220. The second row 218 and the third row 220 can be aligned. For interlock systems 104 located between rows of the modules 102 offset from each other, the interlock system 104 can be in the first position 901 or the second position 903. For interlock systems 104 located between rows of the modules 102 aligned from each other, the interlock system 104 can be in the second position 903.

The spacer 340 can include at least one end. The spacer 340 can include a first end 342 and a second end 344 opposite the first end 342. The spacer 340 can include a midpoint 401 (shown in at least FIG. 4) between the first end 342 and the second end 344. In both the first position 901 and the second position 903, the second end 344 can be in contact with the plate 302. For example, the spacer 340 can be removed from the interlock system 104 and reversed such that the first end 342 extends between modules 102 above the interlock system 104 or modules the interlock system 104 is in contact with. In the first position 901, the second end 344 can be in contact with the back surface 402 while in the second position 903, the second end 344 can be in contact with the front surface 330. The position of the spacer 340 can be determined prior to installation of the interlock system 104 with the modules 102. For example, the spacer 340 can be set to the first position 901 or the second position 903 prior to installation. The spacer 340 can be removed following installation of the interlock system 104.

The second end 344 can have a height and a width greater than a height and a width of the first end 342. The height and the width of the second end 344 can be greater than the height and the width of the second aperture 312 such that the second end 344 may not travel (e.g., move) through the second aperture 312. The first end 342 can have a height and a width less than the height and the width of the second aperture 312, and the spacer 340 can be removed from (e.g., moved to not be in contact with) the plate 302 by moving the first end 342 through the second aperture 312. For example, after the modules 102 are placed into contact with the spacer 340, the spacer 340 can be removed from the interlock system 104.

In various implementations, a width of the spacer 340 can gradually decrease from the second end 344 to the first end 342. For example, a width of the spacer 340 at the midpoint 401 can be less than the width at the second end 344 and greater than the width at the first end 342. In various implementations, the first end 342 of the spacer 340 can be tapered.

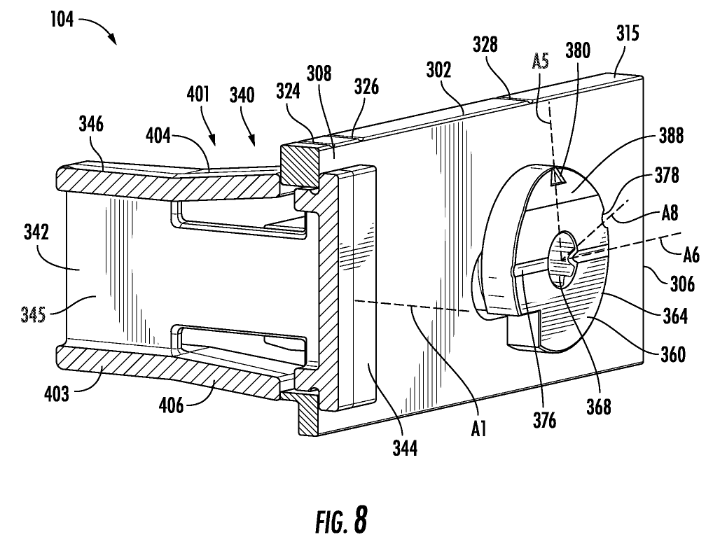

The first end 342 of the spacer 340 can include at least one surface. The first end 342 can include a top surface 346 and a bottom surface 403 opposite the top surface 346. The spacer 340 can include at least one adjustable tab (e.g., prong, tab, member, extension, etc.) The spacer 340 can include a first adjustable tab 404 extending from the top surface 346 at an angle (e.g., first angle) between 5 (e.g., five) to 25 (e.g., twenty five) degrees, inclusive relative to the top surface 346 as shown in at least FIG. 8. The spacer 340 can include a second adjustable tab 406 extending from the bottom surface 403 at an angle (e.g., second angle) between 5 to 25 degrees, inclusive relative to the bottom surface 403. For example, the second adjustable tab 406 can extend in a direction opposite the first adjustable tab 404. The first adjustable tab 404 can extend away from the top surface 346 and the bottom surface 403, and the second adjustable tab 406 can extend away from the bottom surface 403 and the top surface 346. The midpoint 401 of the spacer 340 can be located on and extend from the first adjustable tab 404 to the second adjustable tab 406. In various implementations, the first adjustable tab 404 and the second adjustable tab 406 can extend towards the first end 342.

The first adjustable tab 404 and the second adjustable tab 406 can be adjusted (e.g., moved) towards each other to move the spacer 340 to different positions. For example, to move the spacer 340 through the second aperture 312 to change the spacer 340 between the first position 901 and the second position 903 or to remove the spacer 340 from the plate 302, the first adjustable tab 404 and the second adjustable tab 406 are adjusted such that the angles of the first adjustable tab 404 and the second adjustable tab 406 decrease. The first adjustable tab 404 can be adjusted from an angle of 25 degrees to 0 degrees relative to the top surface 346, and the second adjustable tab 406 can be adjusted from an angle of 25 degrees to 0 degrees relative to the bottom surface 403 to move the spacer 340. The first adjustable tab 404 and the second adjustable tab 406 can be pushed together to adjust the angle. The spacer 340 can be formed from the flexible electrically insulating material such that the first adjustable tab 404 and the second adjustable tab 406 can be moved and pushed together while maintaining electrical insulation of the spacer 340. The first adjustable tab 404 and the second adjustable tab 406 can be configured to actuate (e.g., bend, move) to change a position of the spacer 340 or remove the spacer 340 from the plate 302.

For example, to change the spacer 340 from the first position 901 to the second position, the first adjustable tab 404 and the second adjustable tab 406 can be pushed together to move the spacer 340 through the second aperture 312 such that the spacer 340 is not in contact with the plate 302. The spacer 340 can then be flipped (e.g., reversed) and moved back (e.g., reinserted) through the second aperture 312 until the second end 344 is in contact with the spacer 340. Consequently, the second end 344 can be in contact with the front surface 330 in the second position 903 and the back surface 402 in the first position 901. To remove the spacer 340, the first adjustable tab 404 and the second adjustable tab 406 can be pushed together to move the spacer 340 through the second aperture 312.

The first adjustable tab 404 and the second adjustable tab 406 can have at least one state. The first adjustable tab 404 and the second adjustable tab 406 can have a first state and a second state. The first adjustable tab 404 and the second adjustable tab 406 can be located closer to each other and the first axis A1 in the second state than the first state. To move the spacer 340, the first adjustable tab 404 and the second adjustable tab 406 can be moved from the first state to the second state. The angle of the first adjustable tab 404 and the second adjustable tab 406 relative to the top surface 346 and the bottom surface 403, respectively, can be lower in the second state than the first state.

In the first state, the first adjustable tab 404, the second adjustable tab 406, and the second end 344 can mitigate movement of the spacer 340. For example, in the first state, the first adjustable tab 404 combined with the second adjustable tab 406 can have a height greater than the height of the second aperture 312 and in various implementations, the height can be equal to the height of the second end 344. At least one of the second end 344, the first adjustable tab 404, and the second adjustable tab 406 can be in contact with the plate 302 to mitigate the movement. For example, in the first position 901 and the second position 903, the plate 302 can be sandwiched between (e.g., in contact with) the second end 344, the first adjustable tab 404, and the second adjustable tab 406.

In the second state, the first adjustable tab 404 and the second adjustable tab 406 can enable movement of the spacer 340 through the second aperture 312, and the spacer 340 can be moved to different positions (e.g., first position 901, second position 903, removed). To change from the first state to the second state, the first adjustable tab 404 and the second adjustable tab 406 can be simultaneously pushed together (e.g., towards the first axis A1) by a manual (e.g., outside) force. To maintain the second state to move the spacer 340, the manual force can be maintained on the first adjustable tab 404 and the second adjustable tab 406 such that the angle of the first adjustable tab 404 and the second adjustable tab 406 from the top surface 346 and the bottom surface 403, respectively, remains at, for example, 0 degrees. Absent an outside force, the first adjustable tab 404 and the second adjustable tab 406 can remain in or return towards the first state.

The spacer 340 can include a body 345. The second end 344 can be coupled to or integrated with the body 345, and the body 345 can have a width less than the second end 344, the top surface 346, and the bottom surface 403. The top surface 346, the bottom surface 403, and the second end 344 can be contiguous with the body 345. The top surface 346, the bottom surface 403, the first adjustable tab 404, and the second adjustable tab 406 can extend away from the body 345 such that at least one of the top surface 346, the bottom surface 403, the first adjustable tab 404, or the second adjustable tab 406 can slide against and mate with the frame 207. The spacer 340 can include a space between the first adjustable tab 404 and the body 345, and between the second adjustable tab 406 and the body 345 such that at least a portion of the first adjustable tab 404 and the second adjustable tab 406 is not in contact with the body 345.

In various implementations, the first adjustable tab 404 and the second adjustable tab 406 extend from the body 345. For example, the first adjustable tab 404 and the second adjustable tab 406 are in contact with the body 345. The first adjustable tab 404 can be located between the top surface 346 and the bottom surface 403 and extend towards the first end 304. The second adjustable tab 406 can be located between the top surface 346 and the bottom surface 403 and extend towards the second end 306. In such implementations, the first adjustable tab 404 and the second adjustable tab 406 can be pushed towards the midpoint 308 to move the spacer 340. In such implementations, a width of the spacer 340 and the second aperture 312 can increase, and a height of the spacer 340 and the second aperture 312 can decrease.

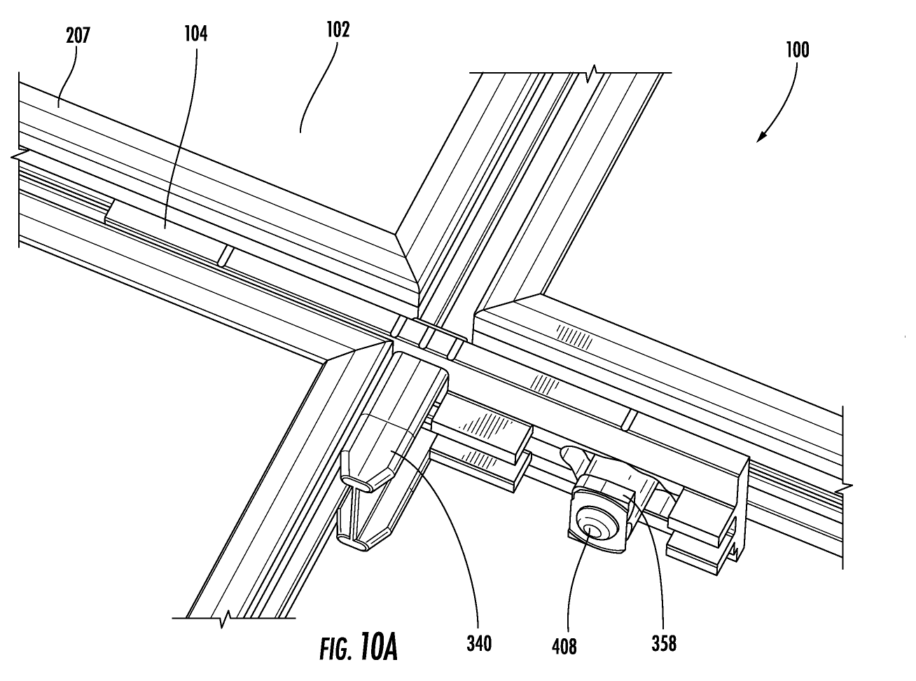

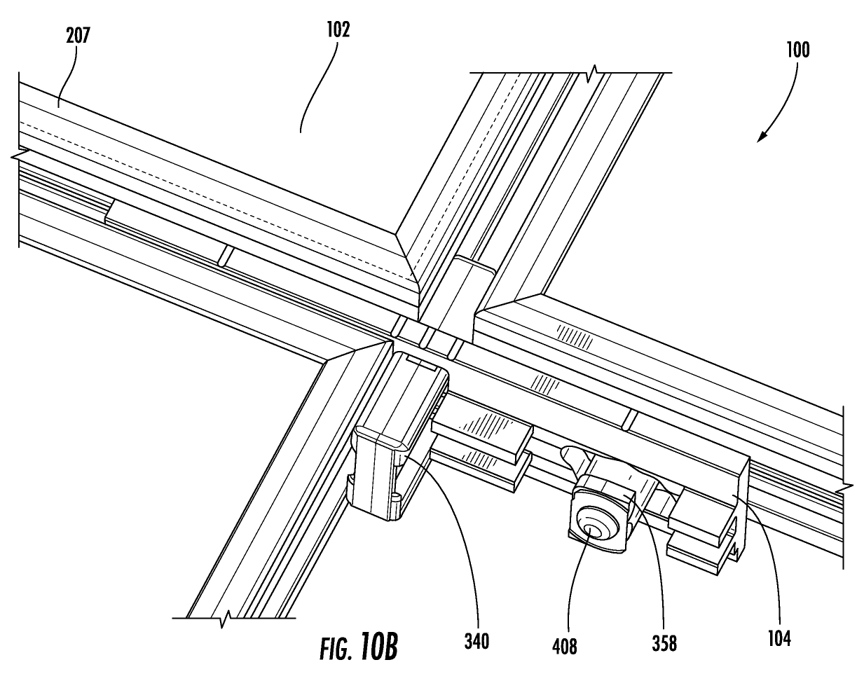

In various implementations, the spacer 340 does not include the first adjustable tab 404 or the second adjustable tab 406. In such implementations, the spacer 340 can include at least one protrusions along the body 345, allowing the spacer 340 to slide between the frame 207 of the modules 102. The spacer 340 can be moved between positions after installation of the interlock system 104 by sliding the spacer 340 along the frames 207. The protrusions can engage with and be located at least partially in the frame 207 to allow for movement of the spacer 340 along the frames 207. Positions and configurations of the spacer 340 without the first adjustable tab 404 or the second adjustable tab 406 can be seen in FIGS. 9B and 10B, as described further herein.

In various implementations, the spacer 340 is not included in the system 100. In such implementations, the second marking 322, the third marking 324, and the fourth marking 326 can be used to space the modules 102 apart. For example, a mechanic can align the frame 207 of the first module 102 with the second marking 322, and the frame 207 of a second module 102 with the fourth marking 326, and a space between the first module 102 and the second module 102 can be defined by a distance between the second marking 322 and the fourth marking 326 on the top surface 315.

The interlock system 104 can include at least one electrical connector 358, 360 (e.g., conductor, terminal, electric coupler, etc.) The electrical connector 358, 360 can be formed from an electrically conductive material, such as a metal like aluminum. The electrical connector 358, 360 can facilitate (e.g., form) an electrical connection between modules 102 by electrically coupling to a first module 102 and facilitating flow of electric current through the plate 302 and the electrical connectors 358, 360 to a second module 102. The electrical connector 358, 360 can enable the grounding of the modules 102 along rows of the modules 102, such as the rows 216, 218, or 220.

The interlock system 104 can include a first electrical connector 358 coupled to the plate 302 and extending at least partially through the first aperture 310. The interlock system 104 can include a second electrical connector 360 coupled to the plate 302 and extending at least partially through the third aperture 314. The first electrical connector 358 and the second electrical connector 360 can be configured to rotate to facilitate electrical connection between modules 102. Rows of the modules 102 (e.g., 216, 218, 220) can be electrically connected at least partially by the first electrical connector 358 and the second electrical connector 360.

The first electrical connector 358 can include at least one end. The first electrical connector 358 can include a first end 408 and a second end 362. The second end 362 can be opposite the first end 408. The second end 362 can be in contact with the front surface 330. In various implementations, the second end 362 is not in contact with the front surface 330, and a gap between the second end 362 and the front surface 330 can be between 0.3 (e.g., zero point three) to 0.7 (e.g., zero point seven) mm. The first end 408 can be in contact with a first module 102, and the second end 362 can be in contact with and/or face a second module 102. During the installation process, the second module 102 can be placed in contact with the second end 362 after the first electrical connector 358 is rotated to electrically couple to the first module 102. The first electrical connector 358 can be rotated while the first end 408 is located at least partially in the frame 207 of the first module 102. The first end 408 can be in contact with the frame 207 and at least partially inserted into the frame 207.

The second electrical connector 360 can include at least one end. The first electrical connector 358 can include a first end 410 and a second end 364. The second end 364 can be opposite the first end 410. The second end 364 can be in contact with the front surface 330. In various implementations, the second end 364 is not in contact with the front surface 330, and a gap between the second end 364 and the front surface 330 is between 0.3 to 0.7 mm, inclusive. The first end 410 can be in contact with a third module 102 and the second end 364 can be in contact and/or can face a fourth module 102. During the installation process, the fourth module 102 can be placed in contact with the second end 364 after the second electrical connector 360 is rotated to electrically couple to the third module 102. The second electrical connector 360 can be rotated while the first end 410 is located at least partially in the frame 207 of the third module 102. The first end 410 can be in contact with the frame 207 and at least partially inserted into the frame 207.

Once the first end 408 is electrically coupled to the first module 102 and the first end 410 is electrically coupled to the third module 102, the interlock system 104 can electrically couple the first module 102 and the third module 102. An electrical current can travel from the first module 102 to the first electrical connector 358 through the plate 302 through the second electrical connector 360 and to the third module 102. In various implementations, the first module 102 is same as the third module 102, or the second module 102 is same as the fourth module 102. For example, at least one end of the first electrical connector 358 and the second electrical connector 360 are in contact with or facing a same module 102.

FIG. 9A shows four configurations of the interlock system 104. In a first configuration 905, the spacer 340 is removed from the plate 302 after both the first electrical connector 358 and the second electrical connector 360 are in contact with and coupled to a base 907 of the array 202. The first end 408 and the first end 410 can be in contact with the base of the array 202. The base 907 can be a part of the structure the modules 102 are mounted to In the first configuration 905, the first electrical connector 358 and the second electrical connector 360 may not be rotated, and the first electrical connector 358 and the second electrical connector 360 can be attached and engage with the surface 204. For example, the base 907 can have a shape that matches the frame 207, allowing insertion of the first electrical connector 358 and the second electrical connector 360. The first configuration 905 can correspond to the point 212.

The interlock system 104 can include a second configuration 909. In the second configuration 909, the spacer 340 can be in contact with a first module 102A and a second module 102B, and the first end 408 and the first end 410 can be in contact with a third module 102C. The spacer 340 can extend in a direction that the second end 362 and the second end 364 face (e.g., towards the first module 102Aand the second module 102B, respectively). The spacer 340 can be in the first position 901, and the spacer 340 being in the first position 901 indicates that the spacer 340 extends between and is in contact with modules 102 above the plate 302. The second configuration 909 can correspond to the point 208. The first end 408 and the first end 410 are in contact with a same module 102, and the interlock system 104 may not electrically connect the modules 102 as a result. In the second configuration 909, the first electrical connector 358 and the second electrical connector 360 can be rotated to allow for thermal expansion of the third module 102C, as described further herein. The interlock system 104 can space apart the first module 102A and the second module 102B.

The interlock system 104 can include a third configuration 911. In the third configuration 911, the spacer 340 can be in contact with a third module 102C and a fourth module 102D. The first end 408 and the first end 410 can be in contact with and coupled to the frames 207 of the third module 102C and the fourth module 102D, and the interlock system 104 can electrically couple the third module 102C and the fourth module 102D. The second end 362 and the second end 364 can face towards a first module 102A and a second module 102B, respectively. The spacer 340 can extend in a direction the first end 408 and the first end 410 are facing (e.g., the third module 102C and the fourth module 102D, respectively) in the third configuration 911. The spacer 340 can be in the second position 903 which can indicate that the spacer 340 extends between and is in contact with modules 102 below the plate 302. The third configuration 911 can correspond to the point 210.

The interlock system 104 can include a fourth configuration 913. In the third configuration 911, the spacer 340 can be in contact with a third module 102C and a fourth module 102D. The first end 408 and the first end 410 can be in contact with and coupled to the frames 207 of the third module 102C and the fourth module 102D, and the interlock system 104 can electrically couple the third module 102C and the fourth module 102D. The second end 362 and the second end 364 can face towards a same module 102. The spacer 340 can extend in a direction the first end 408 and the first end 410 are facing (e.g., the third module 102C and the fourth module 102D, respectively) in the fourth configuration 913. The spacer 340 can be in the second position 903 which can indicate that the spacer 340 extends between and is in contact with modules 102 below the plate 302. The fourth configuration 913 can correspond to the point 208.

To move the spacer 340 between positions 901 and 903, and configurations 905, 909, 911, and 913, the first adjustable tab 404 and the second adjustable tab 406 can be adjusted. For example, to move the interlock system 104 from the third configuration 911 to a configuration where the spacer 340 is removed, the first adjustable tab 404 and the second adjustable tab 406 can be pushed towards each other, and the spacer 340 can be moved in a direction the second end 362 and the second end 364 is facing and removed from the interlock system 104.

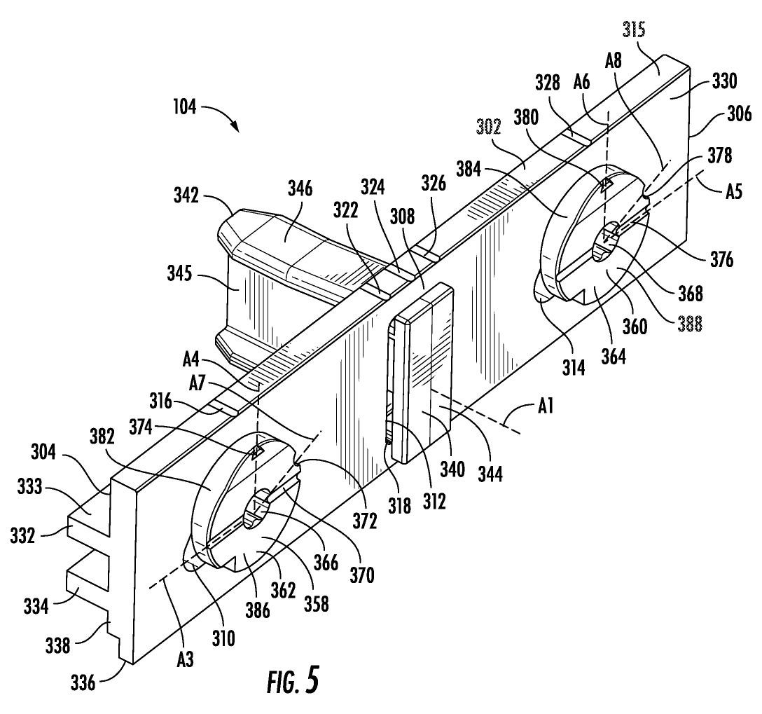

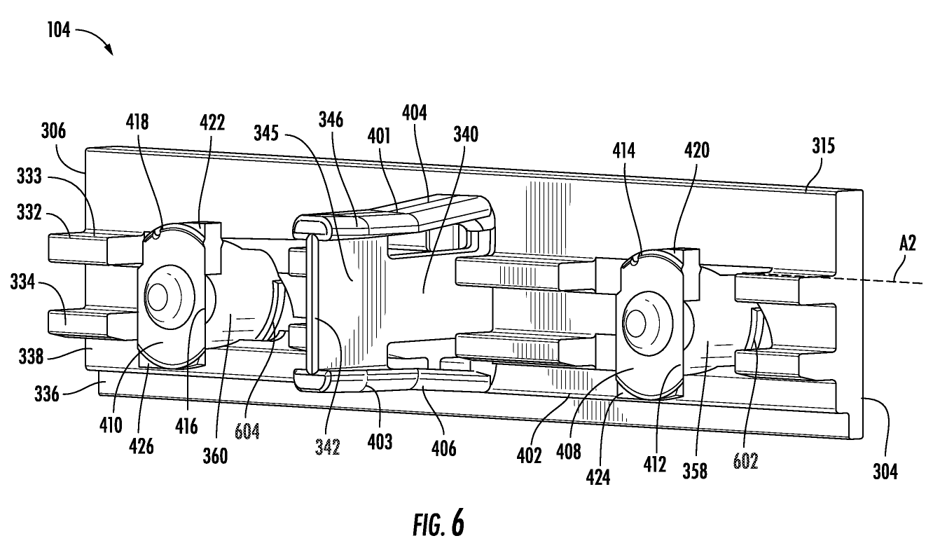

To electrically couple the first electrical connector 358 and the second electrical connector 360 to the modules 102, the first end 408 and the first end 410 can be configured to be rotated within the frame 207. FIGS. 3-4 depict the interlock system 104 in a state where the first electrical connector 358 and the second electrical connector 360 are not yet rotated (e.g., unrotated, initial state, etc.) and FIGS. 5-6 depict the interlock system 104 in a state where the first electrical connector 358 and the second electrical connector 360 are rotated. In various implementations, the interlock system 104 may not electrically couple modules 102 until at least one of the first electrical connector 358 and the second electrical connector 360 are rotated to secure the electrical connection of the interlock system 104 with two modules 102. For example, FIG. 10A depicts the interlock system 104 with the first electrical connector 358 rotated and electrically coupled to a module 102. In the first state, the interlock system 104 can be inserted into (e.g., mated with) the frame 207 and in the second state, the interlock system 104 can, for example, electrically couple modules 102.

The first end 408 can include at least one edge. The first end 408 can include a first edge 412 and a second edge 414 contiguous with the first edge 412. In the state shown in FIGS. 3-4, the first edge 412 can be aligned with and parallel to a second axis A2 extending along the back surface 402. A top surface 333 of the first protrusion 332 can be located along the second axis A2. In various implementations, the first edge 412 is parallel to the second axis A2 within 1 to 5 degrees, inclusive. The first edge 412 can be straight and at least a portion of the second edge 414 can be rounded.

The first end 410 can include at least one edge. The first end 410 can include a first edge 416 and a second edge 418 contiguous with the first edge 416. In the state shown in FIGS. 3-4, the first edge 416 can be aligned with and parallel to the second axis A2 extending along the back surface 402. In various implementations, the first edge 416 is parallel to the second axis A2 within 1 to 5 degrees, inclusive. The first edge 416 can be straight and at least a portion of the second edge 418 can be rounded.

The first end 408 of the first electrical connector 358 can include at least one corner 420 (e.g., portion, stopper, block, etc.). The corner 420 can have an angle between 85 (e.g., eighty five) to 95 (e.g., ninety five) degrees inclusive. At least a portion of the corner 420 can be rounded. The corner 420 can be coupled to at least one of the first edge 412 or the second edge 414. In various implementations, the corner 420 is integrated and contiguous with the first edge 412 and the second edge 414. For example, the first edge 412 and the second edge 414 include the corner 420.

The first end 410 of the second electrical connector 360 can include at least one corner 422. The corner 422 can have an angle between 85 to 95 degrees inclusive. At least a portion of the corner 422 can be rounded. The corner 422 can be coupled to at least one of the first edge 416 or the second edge 418. In various implementations, the corner 422 is integrated and contiguous with the first edge 416 and the second edge 418. For example, the first edge 416 and the second edge 418 include the corner 422.

The first electrical connector 358 and the second electrical connector 360 can be rotated clockwise such that the corner 420 and the corner 422 can contact (e.g., engage with) the frame 207. The corner 420 can limit the first electrical connector 358 from rotating beyond between 88 (e.g., eighty eight) to 92 (e.g., ninety two) degrees, inclusive. The corner 422 can limit the second electrical connector 360 from rotating beyond between 88 to 92 degrees, inclusive. For example, once the corner 420 and the corner 422 contact the frame 207, the first electrical connector 358 and the second electrical connector 360 may not rotate further. The corner 420 and the corner 422 can, as the first electrical connector 358 and the second electrical connector 360 rotate, respectively, extend past the second axis A2. Rotating the first electrical connector 358 and the second electrical connector 360 past 88 to 92 degrees can cause misalignment and increase a difficulty of installing another module 102 to the system 100. In addition, over rotation of the first electrical connector 358 and the second electrical connector 360 can increase a torque the interlock system 104 imparts on the frame 207, leading to increased stress and strain on the first electrical connector 358, the second electrical connector 360, and the plate 302 which can decrease a service life and increase risk of failure of the interlock system 104.

The corner 420 can be a first corner 420, and the first electrical connector 358 can include a second corner 424. The second corner 424 can be located on the first end 408 on a point opposite of the first corner 420. As the first electrical connector 358 rotates, the second corner 424 can contact a different part of the frame 207 from the first corner 420, and can limit the first electrical connector 358 from rotating beyond between 88 to 92 degrees, inclusive. The second corner 424 can have a same shape as the corner 420.

The corner 422 can be a first corner 422, and the second electrical connector 360 can include a second corner 426. The second corner 426 can be located on the first end 410 on a point opposite of the first corner 422. As the second electrical connector 360 rotates, the second corner 426 can contact a different part of the frame 207 from the first corner 422 and can limit the second electrical connector 360 from rotating beyond between 88 to 92 degrees, inclusive. The second corner 426 can have a same shape as the corner 422.

The first electrical connector 358 can include at least one protrusion 602 (e.g., raised surface, bump, rib, etc.) The second electrical connector 360 can include at least one protrusion 604 As the first electrical connector 358 and the second electrical connector 360 are rotated, the protrusion 602, 604 can gouge (e.g., carve into, chisel, dent, etc.) into the plate 302 to further secure the electrical connection between the interlock system 104 and the modules 102, and thereby ground the modules 102. In various implementations, the protrusion 602, 604 is inserted into the plate 302. For example, each of the first aperture 310 and the third aperture 314 can include a receiving space to receive the protrusion 602, 604.

The first electrical connector 358 and the second electrical connector 360 can include at least one position. The first electrical connector 358 and the second electrical connector 360 can include a first position shown in FIGS. 3-4, a second position, and a third position shown in FIGS. 5-6. The first position can correspond to an unrotated state, the second position can correspond to a partially rotated state, and the third position can correspond to a rotated state of the first electrical connector 358 and the second electrical connector 360.

Prior to installation, the first electrical connector 358 and the second electrical connector 360 can be in the first position. In the first position, the interlock system 104 can be attached to the frame 207. The first protrusion 332, the second protrusion 334, the third protrusion 338, the first electrical connector 358, and the second electrical connector 360 can be slid into, inserted into, or otherwise attached to and in contact with the frame 207. In the first position, the first edge 412 and the first edge 416 can be parallel within 0 (e.g., zero) to 5 degrees, inclusive, to the second axis A2. The first electrical connector 358 and the second electrical connector 360 can be rotated to the second position or the third position following attachment of the interlock system 104 to the frame 207.

In situations where the first electrical connector 358 and the second electrical connector 360 are in contact with a same module 102 or the base 907 of the array 202, such as the configuration 905 or 909, the first electrical connector 358 and the second electrical connector 360 can be in the second position. In the second position, the first electrical connector 358 and the second electrical connector 360 can be configured to be rotated to allow for thermal expansion between the modules 102. In the second position, the first electrical connector 358 and the second electrical connector 360 may not electrically connect modules, and instead can provide space (e.g., tolerance) for the modules 102 to move and thermally expand. For example, the frame 207 can include aluminum which can expand at a rate of about 23 to 24 microns per meter per degree Celsius. Contact of the frame 207 with the first end 408 and the first end 410 may change as the module 102 thermal expands and contracts. The first electrical connector 358 and the second electrical connector 360 rotating to the second position can allow for movement of the module 102 within a tolerance which can be defined by a position of the corner 420 and the corner 422 in the second position. The first electrical connector 358 and the second electrical connector 360 being in the second position can hook (e.g., attach) the interlock system 104 to the frame 207 while allowing space for expansion of the module 102. In the second position, the first edge 412 and the first edge 416 can extend along an axis at an angle to the second axis A2 such that the first corner 420 and the first corner 422 extend past the second axis A2.

In situations where the first electrical connector 358 and the second electrical connector 360 are in contact with two modules 102, such as the configuration 911 and 913, the first electrical connector 358 and the second electrical connector 360 can be in the third position. The interlock system 104 can electrically connect two modules 102 in response to at least one of the first electrical connector 350 or the second electrical connector 360 being in the third position. In the third position, the corner 420 and the corner 422 can engage with the frames 207 of the two modules 102 to secure and complete an electrical connection from the first module 102 through the interlock system 104 and to the second module 102. The protrusion 602, 604 can be located at least partially in the plate 302 at the third position to secure the electrical connection and facilitate grounding of the modules 102. For example, as the first electrical connector 358 and the second electrical connector 360 rotate, the protrusion 602, 604 can begin to gouge into the plate 302. The protrusion 602, 604 may begin to gouge into the plate 302 between the second position and the third position of the first electrical connector 358 and the second electrical connector 360. In the third position, the first edge 412 and the first edge 416 can extend along an axis perpendicular to the second axis A2, and the first corner 420 and the first corner 422 can extend past the second axis A2. In various implementations, in the third position, the first edge 412 and the first edge 416 extend along an axis that intersects the second axis A2 at an angle between 88 to 92 degrees, inclusive.

To move the first electrical connector 358 and the second electrical connector 360, the first electrical connector 358 and the second electrical connector 360 can be configured to be rotated clockwise from the first position to the second position and the third position. In various implementations, the first electrical connector 358 and the second electrical connector 360 can be rotated counterclockwise from the first position to the third position. The first electrical connector 358 and the second electrical connector 360 can be rotated using a tool, such as a screwdriver, and can thereby be rotated without a specific tool, simplifying the installation process. The first electrical connector 358 can include an opening 366 to receive a tool and rotate the first electrical connector 358. The second electrical connector 360 can include an opening 368 to receive a tool and rotate the second electrical connector 360.

The second end 362 of the first electrical connector 358 and the second end 364 of the second electrical connector 360 can include at least one indicator (e.g., marking, etc.) The second end 362 of the first electrical connector 358 can include a first indicator 370, a second indicator 372, and a third indicator 374. The second end 364 of the second electrical connector 360 can include a first indicator 376, a second indicator 378, and a third indicator 380. The first indicator 370 and the first indicator 376 can correspond to the first position of the first electrical connector 358 and the second electrical connector 360, the second indicator 372 and the second indicator 378 can correspond to the second position, and the third indicator 374 and the third indicator 380 can correspond to the third position.

The first indicator 370 can extend along a third axis A3 (e.g., first indicator axis). The third indicator 374 can be centered on and extend along a fourth axis A4 (e.g., third indicator axis). The third axis A3 and the fourth axis A4 can intersect at an angle between 88 to 92 degrees inclusive. The first indicator 376 can extend along a fifth axis A5 (e.g., first indicator axis). The third indicator 380 can be centered on and extend along a sixth axis A6 (e.g., third indicator axis). The fifth axis A5 and the sixth axis A6 can intersect at an angle between 88 to 92 degrees inclusive. The second indicator 372 can be centered on and extend along a seventh axis A7. The seventh axis A7 can intersect the third axis A3 at an angle between 5 to 20 degrees, inclusive. The second indicator 378 can be centered on and extend along an eighth axis A8. The eighth axis A8 can intersect the fifth axis A5 at an angle between 5 to 20 degrees, inclusive.

The first indicator 370 and the first indicator 376 can be a line down a middle of the second end 362 and the second end 364, respectively. For example, the first indicator 370 can intersect the opening 366 and the first indicator 376 can intersect the opening 368. The first indicator 370 and the first indicator 376 can be an indented line on the second end 362 and the second end 364, respectively. The second indicator 372 and the second indicator 378 can be indents (e.g., divots, etc.) on the second end 362 and the second end 364, respectively. For example, the second end 362 includes an edge 382 (e.g., rim, periphery, etc.) and the second end 364 includes an edge 384. The first indicator 370 extends from one point along the edge 382 to another point opposite the one point on the edge 382. The first indicator 376 extends from one point along the edge 384 to another point opposite the one point on the edge 384. The second indicator 372 can be an indent on the edge 382 and the second indicator 378 can be an indent on the edge 384. The second indicator 372 and the second indicator 378 can be indents with a concave up shape.

The second end 362 can include a surface 386 contiguous with the edge 382. The edge 382 can extend around the surface 386. The surface 386 can be in contact with and face a module 102. The second end 364 can include a surface 388 contiguous with the edge 384. The edge 384 can extend around the surface 388. The surface 388 can be in contact with and face a module 102. The first indicator 370 can be on the surface 386 and the first indicator 376 can be on the surface 388.

The third indicator 374 can be an indent on the surface 386 and the third indicator 380 can be an indent on the surface 388. The third indicator 374 and the third indicator 380 can have a shape, such as a triangular shape. The first indicator 370 and the first indicator 376 can be an indented line extending along a center of the surface 386 and the surface 388, respectively. In various implementations, the indicators 370, 372, 374, 376, 378, and 380 can have a same shape. For example, each of the indicators 370, 372, 374, 376, 378, and 380 can be an indent on the surface 386 or the surface 388.

To determine (e.g., set, configure, etc.) a position (e.g., first position, second position, third position) of the first electrical connector 358, one of the first indicator 370, the second indicator 372, or the third indicator 374 can be rotated to align with the first marking 316. For example, to set the first electrical connector 358 to the second position, the second indicator 372 can be rotated to align with the first marking 316 which can allow for thermal expansion of the module 102 the first electrical connector 358 is in contact with. FIGS. 3-4 depict the first indicator 370 aligned with the first marking 316, indicating that the first electrical connector 358 is in the first position while FIGS. 5-6 depict the third indicator 374 aligned with the first marking 316, indicating that the first electrical connector 358 is in the third position.

To determine a position of the second electrical connector 360, one of the first indicator 376, the second indicator 378, or the third indicator 380 can be rotated to align with the fifth marking 328. For example, to set the second electrical connector 360 to the second position, the second indicator 378 can be rotated to align with the fifth marking 328 which can allow for thermal expansion of the module 102 the second end 364 is in contact with. FIGS. 3-4 depict the first indicator 376 aligned with the fifth marking 328, indicating that the second electrical connector 360 is in the first position while FIGS. 5-6 depict the third indicator 380 aligned with the fifth marking 328, indicating that the second electrical connector 360 is in the third position.

In various implementations, a position of the second indicator 372 and the third indicator 374 on the surface 386 are located on an opposite side of the first indicator 370 such that to align the second indicator 372 or the third indicator 374 with the first marking 316, the first electrical connector 358 is rotated counterclockwise. In various implementations, a position of the second indicator 378 and the third indicator 380 on the surface 388 are located on an opposite side of the first indicator 376 such that to align the second indicator 378 or the third indicator 380 with the fifth marking 328, the second electrical connector 360 is rotated counterclockwise.

The indicators 370, 372, 374, 376, 378, and 380 can facilitate positioning of the electrical connectors 358 and 360. The indicators 370, 372, 374, 376, 378, and 380 can mark a rotational position of the electrical connectors 358 and 360 and can simplify the installation process. For example, the mechanic can rotate the electrical connectors 358 and 360 either by hand or using a tool to align the second indicator 372 with the first marking 316, and the second indicator 378 with the fifth marking 328 to set the interlock system 104 to space apart the modules 102 while allowing for thermal expansion of the modules 102.

In various implementations, the second end 362 can include a second indent 390 and the second end 364 can include a second indent 392. The second indent 390 can be located on an opposite side of the first indicator 370 from the third indicator 374. The second indent 392 can be located on an opposite side of the first indicator 376 from the third indicator 380.

In various implementations where the spacer 340 does not include the first adjustable tab 404 or the second adjustable tab 406. In such implementations, the spacer 450 can include three configurations of the interlock system 104 as shown in FIG. 9B. In a first configuration 908, the spacer 340 is in contact with four of the modules 102 and in a first position 902, and the first end 408 is in contact with a first module 102A and the second end 362 can face or be in contact with a second module 102B. In the first configuration 908, the first end 410 of the second electrical connector 360 is in contact with a third module 102C and the second end 364 can face or be in contact with a fourth module 102D. The first configuration 908 can correspond to, for example, the point 210 shown in FIG. 2. For example, the interlock system 104 can be in the first configuration 908 at the point 210. The interlock system 104 in the first configuration 908 can electrically couple the third module 102C and the first module 102A, and space apart the first module 102A, the second module 102B, the third module 102C, and the fourth module 102D. FIG. 10B depicts the interlock system 104 with the spacer 340 without the first adjustable tab 404 and the second adjustable tab 406 in the first position 902 and the first configuration 908. In the FIG. 10B, the first electrical connector 358 and the second electrical connector 360 are in the third position.

The interlock system 104 can include a second configuration 910. In the second configuration 910, the first end 408 and the first end 410 are in contact with a same module 102. In such cases, the spacer 340 is in a second position 904, and the interlock system 104 may not electrically connect modules 102. The interlock system 104 in the second configuration 910 can space apart three of the modules 102. The interlock system 104 can be in the second configuration 910 at the point 214.

The interlock system 104 can include a third configuration 912. In the third configuration 912, the first end 408 and the first end 410 can contact different modules 102 while the second end 362 and the second end 364 contact a same module 102. The interlock system 104 can electrically couple the modules 102 the first end 408 and the first end 410 are in contact with. The interlock system 104 can be in the third configuration 912 at the point 208. The interlock system 104 in the third configuration 912 can space apart three of the modules 102. The spacer 340 can be in a third position 906 in the third configuration 912,

In various implementations, as shown in FIG. 9B, a width of the spacer 340 can be equal along a length of the spacer 340. For example, the first end 342 can have a same width as the second end 344. In various implementations, the spacer 340 of FIGS. 9B and 10B is not removable from the plate 302.

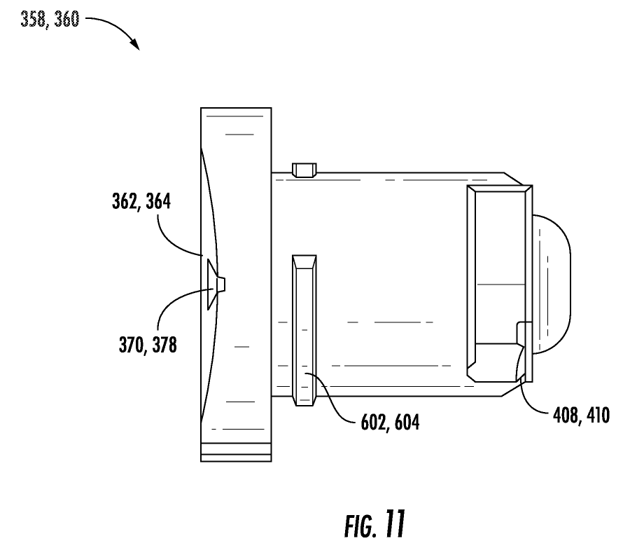

FIGS. 11-13 depict various examples of the first electrical connector 358 and the second electrical connector 360. As shown in FIGS. 11-13, the first electrical connector 358 and the second electrical connector 360 can include the at least one protrusion 602, 604. The protrusion 602, 604 can gouge into the plate 302 as at least one of the first electrical connector 358 or the second electrical connector 360 rotates within at least one of the first aperture 310 or the third aperture 314. For example, as the first electrical connector 358 and the second electrical connector 360 are rotated from the first position to the third position, the protrusion 602, 604 gouges into the plate 302 to further secure the electrical connection between the module 102 and the interlock system 104, and to ground the module 102.

The protrusion 602, 604 can be located closer to the second end 362, 364 than the first end 408, 410. The protrusion 602, 604 can be located in at least one of the first aperture 310 or the third aperture 314 and can gouge into the plate 302 in a portion of the plate 302 defining the at least one of the first aperture 310 or the third aperture 314. The protrusion 602, 604 can extend around at least a portion of the first electrical connector 358 and the second electrical connector 360.

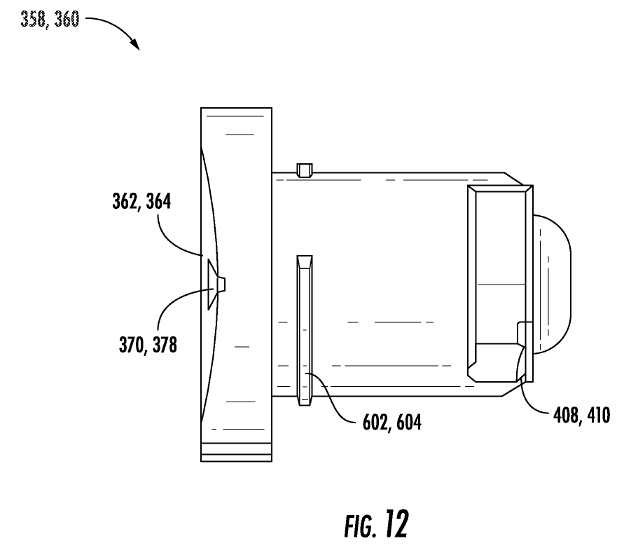

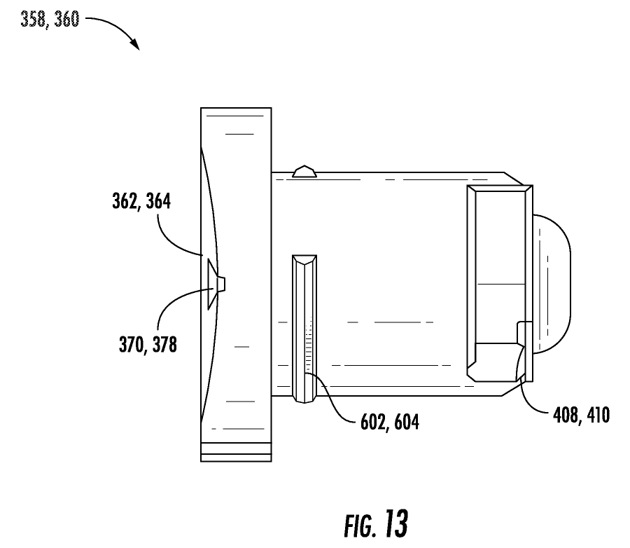

In various implementations, as shown in FIG. 11, the protrusion 602, 604 has a width between 1 to 1.4 (e.g., one point four) mm, inclusive. In various implementations, as shown in FIG. 12, the protrusion 602, 604 has a width between 0.4 (e.g., zero point four) to 0.8 (e.g., zero point eight) mm, inclusive. In various implementations, as shown in FIG. 13, the protrusion 602, 604 can have a width between 1 to 1.4 mm, inclusive, and be chamfered. In various implementations, the protrusion 602, 604 shown in FIG. 12 can impart a lower torque on the plate 302 than the protrusion 602, 604 shown in FIG. 11.

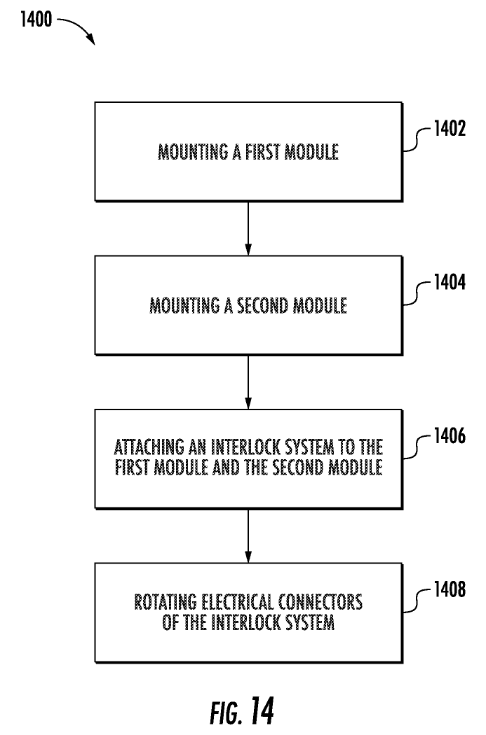

FIG. 14 depicts a flow diagram of an example method 1400 to install the system 100. The method 1400 can be performed using various devices or systems described herein, such as the system 100. The method 1400 can be performed to install a module system (e.g., system 100) to at least one of a roof, rack, mount, ground system, or any other structure. The method 1400 can simplify and decrease an installation time of the module system compared to conventional systems and methods.

The method 1400 can include mounting (e.g., coupling) a first module onto at least one of a rack, frame, mount, or other structure to hold modules (1402). The first module can be coupled by fasteners or clamps and can be secured to the structure. Once the first module is secured, the method 1400 can include attaching a second module to the interlock system (1404). The second module can be coupled by fasteners or clamps and can be secured to the structure. Once the first module and the second module are secured, the method 1400 can include attaching (e.g., coupling) an interlock system between the first module and the second module (1406). The interlock system can be placed into contact with the first module and the second module. Specifically, a frame of the first module and the second module can engage with the interlock system. The interlock system can mate with the frame of the first module and the second module to attach the interlock system to the first module and the second module. The interlock system can include a spacer, and the spacer can be positioned depending on a configuration of a module system. For example, the first module and the second module can be included in an array of modules, and the spacer can be positioned depending on a position of the first module and the second modules within the array of modules. For example, the spacer can be positioned to contact modules other than the first module and the second module.

. After the interlock system is in contact with two modules, the method 1400 can include rotating electrical connectors of the interlock system to electrically couple the interlock system and the two modules together (1408). To continue installing the array of modules, additional modules can be mounted to the structure, and the interlock system can be placed at points of the array of modules as pairs of modules are installed. For modules above the interlock system (e.g., from a top view of the array of modules), the electrical connectors can contact the modules but may not provide an electrical connection. In various implementations, the electrical connectors of the interlock system are rotated to allow thermal expansion of the modules and may not facilitate an electrical connection between modules. Consequently, the interlock system can electrically connect rows of modules and ground the rows of the modules. The interlock system can be located along a top edge of the rows of modules.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “example” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or movable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other example embodiments, and that such variations are intended to be encompassed by the present disclosure.

It is important to note that the construction and arrangement of the systems, apparatuses, and methods shown in the various example embodiments is illustrative only. Additionally, any element disclosed in one embodiment may be incorporated or utilized with any other embodiment disclosed herein. For example, any of the example embodiments described in FIGS. 1-14 of this application can be incorporated with any of the other example embodiment described. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An interlock system for photovoltaic modules, comprising:
a plate defining a first aperture, a second aperture, and a third aperture;
a spacer removably coupled to the plate and extending at least partially through the second aperture, the spacer comprising a first adjustable tab and a second adjustable tab, the spacer movable through the second aperture via the first adjustable tab and the second adjustable tab;
a first electrical connector coupled to the plate and extending at least partially through the first aperture, the first electrical connector configured to rotate to form an electrical connection; and
a second electrical connector coupled to the plate and extending at least partially through the third aperture, the second electrical connector configured to rotate to form the electrical connection.

2. The interlock system of claim 1, wherein the spacer comprises:
a first end having a top surface and a bottom surface, the bottom surface opposite the top surface;
the first adjustable tab extends from the top surface at a first angle between five to twenty five degrees, inclusive; and
the second adjustable tab extends from the bottom surface at a second angle between five to twenty five degrees, inclusive.

3. The interlock system of claim 2, wherein the spacer comprises a second end opposite the first end, the second end having a height and a width greater than a height and a width of the second aperture.

4. The interlock system of claim 1, wherein the plate comprises an electrically conductive material.

5. The interlock system of claim 1, wherein the plate has a length between one hundred and thirty to one hundred and fifty millimeters (mm), inclusive, and a height between twenty five to forty five mm, inclusive.

6. The interlock system of claim 1, wherein the spacer comprises an electrically insulating material.

7. The interlock system of claim 1, wherein:
the second aperture is located between the first aperture and the third aperture, the first aperture and the third aperture equidistant from the second aperture, and
at least one of the first electrical connector or the second electrical connector comprises at least one protrusion, the at least one protrusion configured to gouge into the plate as the first electrical connector and the second electrical connector are rotated.

8. The interlock system of claim 1, wherein:
at least one of the first electrical connector or the second electrical connector has a first position, a second position, and a third position, the first position corresponding to an unrotated state, the second position corresponding to a partially rotated state, and the third position corresponding to a rotated state, the first electrical connector and the second electrical connector forming the electrical connection in the third position,
at least one of the first electrical connector or the second electrical connector comprises a first indicator corresponding to the first position, a second indicator corresponding to the second position, and a third indicator corresponding to the third position, and
the first indicator extends along a first axis and the third indicator extends along a third axis, the third axis intersecting the first axis at an angle between eighty eight to ninety two degrees, inclusive.

9. A module system, comprising:
a plurality of modules configured to generate electricity; and
at least one interlock device configured to space the plurality of modules apart and electrically connect at least a portion of the plurality of modules, comprising:
a plate defining a first aperture, a second aperture, and a third aperture;
a spacer coupled to the plate and extending at least partially and movable through the second aperture, the spacer in contact with at least two of the plurality of modules and configured to separate the at least two of the plurality of modules;
a first electrical connector coupled to the plate and extending at least partially through the first aperture configured to electrically connect the at least the portion of the plurality of modules; and
a second electrical connector coupled to the plate and extending at least partially through the second aperture configured to electrically connect the at least the portion of the plurality of modules.

10. The module system of claim 9, wherein:
the first electrical connector comprises:
a first end configured to contact at a first module of the plurality of modules, and
a second end configured to face a second module of the plurality of modules;
the second electrical connector comprises:
a first end configured to contact at a third module of the plurality of modules, and
a second end configured to face a fourth module of the plurality of modules.

11. The module system of claim 10, wherein the third module is same as the first module or the second module is same as the fourth module.

12. The module system of claim 10, wherein the first end of the first electrical connector and the first end of the second electrical connector have a corner with an angle between eighty five to ninety five degrees, inclusive, the corner limiting the first electrical connector and the second electrical connector from rotating beyond between eighty eight to ninety two degrees, inclusive.

13. The module system of claim 10, wherein:
at least one of the first electrical connector or the second electrical connector has a first position, a second position, and a third position, the first position corresponding to an unrotated state, the second position corresponding to a partially rotated state, and the third position corresponding to a rotated state; and
the at least one interlock device electrically connects the at least the portion of the plurality of modules in response to at least one of the first electrical connector or the second electrical connector being in the third position.

14. The module system of claim 13, wherein:
at least one of the second end of the first electrical connector or the second end of the second electrical connector comprises a first indicator, a second indicator, and a third indicator, the first indicator corresponding to the first position, the second indicator corresponding to the second position, and the third indicator corresponding to the third position; and
the first indicator extends along a first axis and the third indicator extends along a third axis, the third axis intersecting the first axis at an angle between eighty eight to ninety two degrees, inclusive.

15. The module system of claim 9, wherein the spacer is in a first position, second position, or removed from the at least one interlock device, the spacer in contact with two modules of the plurality of modules in the first position and the second position.

16. The module system of claim 9, wherein the plate comprises a top surface comprising a first mark aligned with a midpoint of the first aperture, a second mark aligned with a first edge of the second aperture, a third mark aligned with a midpoint of the second aperture, a fourth mark aligned with a second end of the second aperture, and a fifth mark aligned with a midpoint of the third aperture.

17. The module system of claim 16, wherein the plate comprises a back surface contiguous with the top surface comprising at least one protrusion configured to facilitate alignment of the at least one interlock device with at least one of the plurality of modules.

18. An interlock apparatus, comprising:
a plate defining a first opening, a second opening, and a third opening, the second opening located between the first opening and the third opening; and
a spacer coupled to the plate extending at least partially and movable through the second opening, the spacer comprising:
a first surface;
a first prong extending from the first surface;
a second surface; and
a second prong extending from the second surface;
wherein the first prong and the second prong have a first state and a second state, the first prong and the second prong located closer to each other in the second state than the first state, the spacer movable through the second opening when the first prong and the second prong are in the second state.

19. The interlock apparatus of claim 18, wherein the spacer comprises an electrically insulating material, the first prong and the second prong configured to be pushed together to adjust from the first state to the second state.

20. The interlock apparatus of claim 18, further comprising:
at least one electrical connector coupled to the plate and extending at least partially through at least one of the first opening or the third opening, the at least one electrical connector configured to rotate to form an electrical connection.
